(19) United States
(12) Patent Application Publication
(10) Pub. No.: US 2005/0266209 A1
(43) Pub. Date: Dec. 1, 2005

(54) Absorbent bricketts and method of use

(76) Inventor: Darrell W. Coble SR., Broken Arrow, OK (US)

Correspondence Address: SIMON, GALASSO & FRANTZ PLC., P.O. Box 26503, Austin, TX, 78755-0503, US

(21) Appl. No.: 10/914,251

(22) Filed: Aug. 9, 2004

Related U.S. Application Data
(60) Provisional application No. 60/494,035, filed on Aug. 8, 2003.

(51) Int. Cl. B32B 1/00

(52) U.S. Cl. 428/156; 428/76

(57) ABSTRACT

Bricketts for absorbing fluids leaked from an automobile are disclosed. In one form, a brickett includes an upper surface and a lower surface. An absorbent material is integrated as a part of at least one surface of the surface. The absorbent material may be dislodged from the brickett when placed in frictional contact with a surface including the leaked fluid.

### CROSS REFERENCE TO RELATED APPLICATIONS

This application claims priority to co-pending U.S. Provisional Patent Application having Ser. No. 60/494,035 filed Aug. 8, 2003 entitled “Absorbent Bricketts”, having a common applicant herewith.

### FIELD OF THE DISCLOSURE

The invention relates generally to absorbent materials, and more particularly to absorbent bricketts and method of use.

### BACKGROUND

Used oil is toxic because of the products of incomplete fuel combustion. If improperly disposed of, oil can contaminate drinking water supplies and food chains. A single quart of motor oil dumped on the ground can seep into groundwater and pollute 250,000 gallons of drinking water. Additionally, oil or other chemicals that are introduced to storm drains often flush directly into surface waters.

Antifreeze is also a hazardous liquid. Antifreeze is deadly to animals and children and especially dangerous because of its sweet taste. It contains ethylene glycol and picks up toxics in the engine, such as benzene and lead. Consumption of such liquid could result in permanent damage to children or animals. As such, what is needed is an apparatus that captures liquids, and in particular, reduces the introduction of hazardous materials to the environment.

### BRIEF DESCRIPTION OF THE DRAWINGS

Other advantages, features and characteristics of the invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 illustrates an absorbent brickett according to one embodiment of the invention;

FIG. 2 illustrates a cross-sectional view of an absorbent brickett according to one embodiment of the invention; and

FIG. 3 illustrates a cylindrical-shaped absorbent brickett according to one embodiment of the invention.

### DETAILED DESCRIPTION OF THE FIGURES

An absorbent brickett for absorbing fluids leaked from vehicles is disclosed. In one form, an absorbent brickett includes an upper surface, a lower surface and an absorbent material integrated as a part of at least one of the surfaces. The absorbent material absorbs liquids that come in contact with either the upper surface or lower surface of the absorbent brickett. In a particular form, an absorbent brickett includes an absorbent material that may be dislodged from the brickett when placed in frictional contact with a surface including the leaked fluid. In this manner, absorbent material may be used in brickett form and/or particular form as needed.

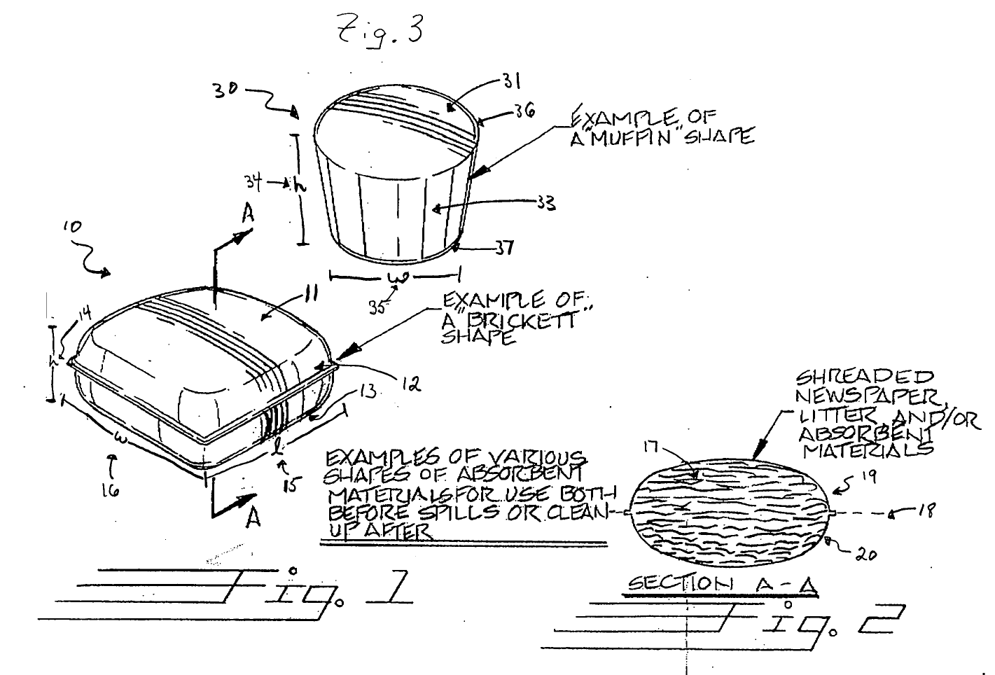

FIG. 1 illustrates an absorbent brickett according to one embodiment of the invention. An absorbent brickett 10 includes an upper surface 11, a lower surface 13 and sides 12. Absorbent brickett 10 may be provided in various sizes or shapes having height 14, width 16 and length 15. In one form, absorbent brickett may be rectangular or square shaped having upper surface 11 and lower surface 13 shaped as convex surfaces (i.e. dome-like). For example, absorbent brickett 10 may include height 14 of approximately one and a half inches (1.5″), a width 16 of approximately three and a quarter inches (3.25″) and a length 15 of approximately three and a quarter inches (3.25″).

Absorbent brickett 10 may be made of any absorbent material that may facilitate absorbing fluids. For example, absorbent brickett 10 may include one or more types of paper products such as recycled newspaper, phone books, cardboard, compost materials (i.e. corn based, etc.) and the like that may be form pressed into absorbent brickett 10 using a conventional form pressing technique. An adhesive material may also be used to form brickett 10 including glue, or combinations of glue or an adhesive with dry or liquid cleaning materials to further enhance removal or disbursement of a liquid. Other materials may also be used in addition to, or in substitute of, paper products. For example, a granular type material such as powder, saw dust, sand, litter, charcoal, limestone, etc. or other granular type materials having absorbent properties may be used as an absorbent material for absorbent brickett 10.

Absorbent brickett 10 may be used in one or more ways to absorb fluids leaked or spilled from a vehicle at a spill location (not expressly shown). For example, a user may place absorbent brickett 10 over a location having a leak and absorbent material of absorbent brickett 10 may absorb fluids incident to lower surface 13. After a period of time, absorbent brickett 10 may be flipped over or rotated to allow upper surface 11 to contact the spill location and absorb the liquid accordingly.

In another embodiment, a user may introduce a sliding force to absorbent brickett 10 to move absorbent brickett 10 along surface having the spill or leakage site. Absorbent brickett 10 may also include absorbent material that may become dislodged as absorbent brickett 10 is moved along the surface. For example, a paper-based material or granular type material provided as a part of absorbent brickett 10 may disengage or become dislodged. The dislodged material may then remain within the leakage site and absorb the leaked fluid. In this manner, a user may cover a portion or all of a leakage site using dislodged absorbent material and may discard the material at a later time by sweeping the material to remove the material from the leakage site. A user may then repeat the process as needed.

An alternative use of absorbent brickett 10 may include placing one or more absorbent bricketts 10 beneath a vehicle to capture leaks as they occur. For example, a vehicle having mechanical difficulties may include one or more oil seals or enclosures that have worn over time and the vehicle may periodically leak oil throughout the day or evening. As such, a user may place one or more absorbent bricketts 10 underneath the vehicle at a location aligned with the active leak. In this manner, absorbent brickett 10 may shield or protect the ground, garage surface, driveway, etc. thereby substantially reducing the exposure area for potentially toxic fluids or liquids that may be leaked from a vehicle. A user may then remove absorbent brickett 10 upon becoming saturated. Additionally, absorbent brickett 10 may also include absorbent material that may be dislodged to absorb liquids that were not incident to absorbent brickett 10. In this manner, absorbent brickett 10 may be used during and after a leak occurs to remove liquids leaked from a vehicle.

FIG. 2 illustrates a cross-sectional view of an absorbent brickett according to one embodiment of the invention. Cross section A-A illustrates one example of a cross section view of an absorbent brickett such as absorbent brickett 10 illustrated in FIG. 1. Absorbent material 17 may be provided within an upper portion 19 and/or lower portion 20 graphically illustrated by median 18. Cross section A-A further illustrates convex shaped surfaces for upper portion 19 and lower portion 20. As described above, one or more types of materials may be used to provide absorbent qualities for absorbent material 17. In one embodiment, absorbent material 17 may include the same material in upper portion 19 and lower portion 20. However, in other embodiments, upper portion 19 may include a different type absorbent material 17 than lower portion 20. For example, upper portion 19 may include a slower absorbing material than lower portion 20 allowing for varying absorption rates for different portions of an absorption brickett.

In another embodiment, various densities of absorbent material 17 may be provided to allow for increased absorption rates and volumes of liquids. For example, a higher density of material may be provided along a surface of upper portion 19 to allow for expedient absorption of liquids. In another embodiment, different material types may also be provided as needed based on the type of use for an absorbent brickett. For example, absorbent material 17 may be constructed to specifically absorb oil and as such may be provided with absorbent material 17 for absorbing oil resulting in an oil absorbing-type brickett. Similarly, absorbent material 17 may be provided to specifically absorb anti-freeze and as such may be provided with absorbent material 17 operable to absorb anti-freeze resulting in an anti-freeze absorbing brickett. Various combinations of materials may be used based on a preferred use of an absorbent brickett.

FIG. 3 illustrates a cylindrical-shaped absorbent brickett according to one embodiment of the invention. Cylindrical-shaped absorbent brickett 30 includes a main body 33 including an upper surface 31 and a lower surface 32 displaced by height 34. Body 33 also includes a width 35. In one embodiment, height 34 may be approximately three (3) inches and width 35 may be approximately three and one half (3.5″) inches however other dimensions may also be used. Upper surface 31 further includes a first circumference 36 and lower surface 32 includes a second circumference 37. First circumference 36 and second circumference 37 may be approximately equal however in other embodiments they may be different. For example, second circumference 37 may be sized smaller than first circumference 36 providing a tapering of cylindrical-shaped absorbent brickett 30.

Upper surface 31 may also include the same type of geometric surface as lower surface 32. For example, upper surface 31 and lower surface 32 may include substantially planar surfaces. However, in other embodiments, upper surface 31 may include a convex, concave, funnel, etc. type geometry while lower surface 32 includes a planar type surface. For example, upper surface 31 may include a convex shape and as such cylindrical-shaped absorbent brickett 30 may appear dome-like or muffin-like. In another embodiment, upper surface 31 may include a concave surface allowing for liquid to gather within a cavity and be absorbed into body 33 of cylindrical-shaped absorbent brickett 30.

During use, cylindrical-shaped absorbent brickett 30 may be placed beneath a vehicle (not expressly shown) to absorb liquids. For example, upper surface 31 including a convex surface allows for liquids to disperse along upper surface 31 and absorb into body 33. As such, various heights 34 may be used depending on the amount of liquid or fluid leaking from a vehicle. In another embodiment, upper surface 31 may include a funnel shaped surface allowing for capturing and funneling of fluids to body 33. For example, a vehicle may quickly leak fluids and as such a funnel shaped may be preferred.

In another embodiment, brickett 10 of FIG. 1 and/or cylindrical-shaped absorbent brickett 30 of FIG. 3 may be modified or formed to be coupled to a portion of a power tool or motor operated tool. For example, brickett 10 may be adapted to be placed onto a gasoline-powered grass trimming device (i.e. weed eater, etc.) or other power tool having a rotating drum or surface and may include an aperture or hole (i.e. a donut-shaped brickett) to couple the brickett on a rotating surface of a power tool and provide a scrubbing. In this manner, portions of absorbent brickett may be efficiently dislodged along a spill site to absorb a fluid. In another embodiment, an absorbent brickett may be formed in an elongated shaped and coupled to the end or head portion of a brush. In this manner, absorbent brickett may be used as a brush or a broom to remove an liquid from a spill site.

Note that although an embodiment of the invention has been shown and described in detail herein, along with certain variants thereof, many other varied embodiments that incorporate the teachings of the invention may be easily constructed by those skilled in the art. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the invention is not intended to be limited to the specific form set forth herein, but on the contrary, it is intended to cover such alternatives, modifications, and equivalents, as can be reasonably included within the spirit and scope of the invention.

1. An apparatus for absorbing fluids leaked from a vehicle comprising:
a brickett including an upper surface and a lower surface;
an absorbent material integrated as a part of at least one of the surfaces; and
wherein the absorbent material is operable to dislodge from the brickett when placed in frictional contact with a surface including the leaked fluid.

2. The apparatus as recited in claim I further comprising the brickett formed in a substantially rectangular shape.

3. The apparatus as recited in claim 2 further comprising:
a width of at least three (3) inches; and
a length of at least four (4) inches.

4. The apparatus as recited in claim 1 further comprising the brickett formed in a substantially cylindrical shape.

5. The apparatus as recited in claim 4 further comprising:
the upper surface including a first circumference; and
the lower surface including a second circumference that is less than the first circumference.

6. The apparatus as recited in claim 5 further comprising the upper surface including a concave surface.

7. The apparatus as recited in claim 5 further comprising:
the upper surface including a convex shaped surface; and
the lower surface including a planar surface.

8. The apparatus of claim 1 further comprising means for providing an absorbent material.

9. The apparatus as recited in claim 1 further comprising the absorbent material integrated throughout a substantial portion of the brickett.

10. The apparatus as recited in claim 1 further comprising the absorbent material integrated as a portion of the brickett.

11. An apparatus for removing fluids leaked from a vehicle and onto a surface beneath the vehicle, the apparatus comprising:
a brickett sized to fit beneath a vehicle;
an absorbent material integrated throughout the brickett to absorb a fluid leaked from the vehicle; and
at least one convex surface including the absorbent material.

12. The apparatus as recited in claim 11 wherein the absorbent material comprises a paper based material.

13. The apparatus as recited in claim 11 wherein the absorbent material comprises a granular based material.

14. The apparatus as recited in claim 12 wherein the absorbent material includes a paper based material and a granular based material.

15. The apparatus of claim 14 further comprising at least one of the paper based material or the granular based material disengagebly coupled to a bottom surface of the brickett.

16. The apparatus of claim 15 further comprising the brickett including a substantially rectangular shape.

17. The apparatus of claim 16 further comprising the brickett including a substantially cylindrical shape.

18. A brickett for absorbing a fluid leaked from an automobile comprising:
a material formed as the brickett, the material comprising at least a paper based product; and
the brickett including:
a length of at least three (3) inches;
a height of at least one (1) inch; and
a width of at least three (3) inches.

19. The brickett of claim 18 further comprising the paper material disengagebly coupled to the brickett.

20. The brickett of claim 19 further comprising an upper surface including a convex portion.
